(19) United States
(12) Patent Application Publication
(10) Pub. No.: US 2022/0411177 A1
(43) Pub. Date: Dec. 29, 2022

(54) CONTAINER FLOORING

(71) Applicant: LIGNOR LIMITED, East Melbourne, Victoria (AU)

(72) Inventor: Peter Edward BURTON, Queensland (AU)

(73) Assignee: LIGNOR LIMITED, East Melbourne, Victoria (AU)

(21) Appl. No.: 17/761,275

(22) PCT Filed: Sep. 18, 2020
(86) PCT No.: PCT/AU2020/050993

§ 371 Date: Mar. 17, 2022

(30) Foreign Application Priority Data
Sep. 20, 2019 (AU) 2019903505

(51) Int. Cl. B65D 90/02; B32B 21/04; B32B 7/12; B32B 21/06; B32B 21/02; B32B 7/03; B32B 37/18; B32B 37/12; B27D 1/08

(52) U.S. Cl. CPC B65D 90/022; B32B 21/042; B32B 7/12; B32B 21/06; B32B 21/02; B32B 7/03; B32B 37/18; B32B 37/12; B27D 1/08; B32B 2307/732; B32B 2439/00; B32B 2307/764; B32B 2260/026; B32B 2260/046; B32B 2307/514; B32B 2317/16; B32B 2307/72; B32B 2317/12; B27N 3/002

(57) ABSTRACT

A method for providing container flooring for a container, including: providing a plurality of container flooring boards, each including a plurality of strand layers including strands of wood bonded together, at least a top strand layer and a bottom strand layer of the container flooring board having its strands substantially aligned in a first direction, and a dimension of the container flooring board in a second direction that is perpendicular to the first direction being selected to extend laterally between sides of the container in use; and arranging the container flooring boards inside the container, each container flooring board being positioned so that the strands of the top strand layer and the bottom strand layer are substantially aligned longitudinally relative to the container and the container flooring board extends laterally between the sides of the container, and respective edges of adjacent container flooring boards abut one another.

### BACKGROUND OF THE INVENTION

The present invention relates to providing container flooring for a container using container flooring boards including layers of strands of wood bonded together with a binder.

### DESCRIPTION OF THE PRIOR ART

A standard container (also referred to as a shipping container or an intermodal freight container, among other names) can carry up to 24 tonnes cargo fully loaded. The flooring of the container is the main structural component to carry the cargo loading. Container flooring must meet high requirements for mechanical performance, impact resistance, and durability.

The Institute of International Container Lessors (IICL) defines performance standards for containers and container flooring. The IICL is the leading trade association of the marine container leasing and chassis provider industry. IICL container leasing member companies engage in leasing marine cargo containers to ship operators and others on a broad international basis.

Standard containers will typically have a basic structure similar to the example shown in FIG. 1, in which the container 100 includes a frame, walls (hidden for clarity), floor supports, and flooring (also hidden for clarity). The frame is generally made up of top side beams 110, top end beams 120, corner posts 130, bottom end beams 140 and bottom side beams 150, typically formed from steel sections. These frame components may be interconnected by corner castings 160. The walls can vary in construction depending on requirements but are often formed from corrugated sheet metal.

Standard containers are typically 2.44 m (8 ft) wide by 2.59 m (8 ft 6 in) high, and may be provided at different lengths varying from 2.44 (8 ft) to 17.1 m to (56 ft), although the majority of the world's containers are either 6.1 m (20 ft) or 12.2 m (40 ft).

The floor supports are typically provided in the form of cross members 170 that extend substantially across the width W of the container 100, and are spaced apart at regular intervals across the length L of the container 100. These cross members 170 run across the container and are welded to the bottom side beams 150 along either side of the container 100. The container 100 may also include forklift pockets 180, which in this example are provided by beams with rectangular hollow cross sections which act as floor supports where they replace the need for cross members 170 at their locations.

The container flooring is typically formed by arranging floorboards over the floor supports. Traditionally the container industry has relied on high-density hardwood species from the tropical forest to produce multiple-layer thick plywood as container floorboards.

Plywood is manufactured as a laminate of veneers oriented such that the grain direction of each layer is perpendicular to that of adjacent layers, resulting in a board product having good performance characteristics in both the longitudinal and lateral directions, suitable for flooring or panelling applications. However, the availability of good quality peeling logs for producing veneers is dwindling, and the once-common use of old growth forests to supply the wood veneer industry has been of increasing environmental concern.

The traditional plywood container floorboard panel will also have a minimum overall thickness of 28 mm and a minimum density of 700 kg/m³ (at time of manufacture), as defined by the IICL. The traditional plywood container floorboard panel is sized approximately 2.44 m×1.21 m (8 ft×4 ft). Due to the way logs are peeled into veneers and the handling equipment, manufacturing methods dictated that the panels would only be supplied in this size and were a compromise compared with a full width panel allowing better dispersion of the sheering stress forces on loading of the container.

A typical arrangement of traditional container floorboard panels for providing flooring in a standard 6.1 m (20 ft) long container is shown in FIG. 2. The full length floorboard panels 201 are arranged such that their long sides are aligned with the length L of the container and their short sides are aligned with the width W of the container. As a result, pairs of floorboard panels 210 are arranged side-by-side across the width W of the container, with adjacent floorboard panels 210 having respective long side edges abutting one another along a centreline 201 of the container.

Turning back to the floor support arrangement shown in FIG. 1, it will be appreciated that the abutting long side edges of the floorboard panels 210 along the centreline 201 of the container will be mostly unsupported since they will not have any underlying floor support structure except at the intersections with the laterally spanning cross members 160.

Tropical high-density hardwood species such as Apitong and Keruing have long growth cycles. Tropical hardwood forests are rapidly diminishing. To protect the environment and decrease the consumption of tropical hardwood, new types of container flooring using environmentally friendly species from plantations or managed forests have been developed, such as Bamboo veneered oriented strand board (OSB).

Wood strand products such as OSB have seen increased use, particularly in North America, and have become a lower cost alternative to wood veneer products such as plywood in a number of structural applications. Wood strands are formed by cutting elongated, thin flakes of wood from logs which can be of lower quality and sourced from renewable plantation resources. By stranding the logs, any faults in the wood are distributed homogeneously through the final product rather than staying intact as a potential failure point.

Strand products are typically formed by coating the strands with a binder, depositing the strands into a mat, and then heating and pressing the mat to cure the binder. Orientation of the strands as they are deposited into the mat will generally improve the performance qualities in the orientation direction. Continuous manufacturing processes are typically used, with the forming processes occurring sequentially as the product moves through the manufacturing plant along a conveyor belt, or the like.

In the case of OSB, boards are manufactured such that the mats have layers of strands with different orientations. Typical OSB products have outer layers with strands oriented length-wise and a core layer with strands oriented randomly, or cross-wise. These layers are built up as part of the mat forming process by sequentially depositing layers of strands with different orientations, with the thickness of the layers typically controlled by the weight of the mat at stages of the mat forming process.

AU2004314464B2 discloses a hard wood strand product including substantially aligned strands of one or more eucalypts bonded together with a binder including an isocyanate resin.

AU2011202472B2 discloses a cross laminated strand product formed from a laminate of a plurality of layers, wherein each layer includes substantially aligned strands of wood bonded together with a binder including an isocyanate resin, and wherein the respective strands of adjacent layers are oriented substantially perpendicularly to one another.

U.S. Pat. No. 7,981,233B2 discloses a method of forming a board suitable for use as container flooring uses bamboo and fast-growth low-density wood. The method includes the step of overlaying thin layers of high-density bamboo composites on surfaces of a core layer which can be the composite of wood veneer and wood strand-based composite, or wood veneer and bamboo stripe sheet composite. The benefits of bamboo and wood materials are combined to produce a bamboo-wood composite board having sufficient mechanical and physical strength and durability for use as container flooring.

US2009/0181209A1 discloses reinforced composite container flooring with resin-impregnated veneers, a core layer which may be formed from a structural strand-based panel or a multi-layer wood veneer panel, and its manufacturing processes.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In one broad form an aspect of the present invention seeks to provide a method for providing container flooring for a container, the method including: providing a plurality of container flooring boards, each container flooring board including a plurality of strand layers, each strand layer including strands of wood bonded together with a binder including an isocyanate resin, wherein at least a top strand layer and a bottom strand layer of the container flooring board has its strands substantially aligned in a first direction, and wherein a dimension of the container flooring board in a second direction that is perpendicular to the first direction is selected to extend laterally between sides of the container in use; and arranging the plurality of container flooring boards inside the container to provide container flooring, wherein each container flooring board is positioned so that the strands of the top strand layer and the bottom strand layer of the container flooring board are substantially aligned longitudinally relative to the container and the container flooring board extends laterally between the sides of the container, and wherein respective edges of adjacent container flooring boards abut one another.

In one embodiment, each container flooring board has a dimension in the second direction of about 2.4 m.

In one embodiment, at least some of the container flooring boards have a dimension in the first direction of one of: about 1.2 m; and about 2.4 m.

In one embodiment, each container flooring board has a minimum thickness of about 28 mm.

In one embodiment, each container flooring board is formed from a laminate of the plurality of strand layers, each strand layer including at least one pre-formed strand board including substantially aligned strands, the respective strands of adjacent layers being oriented substantially perpendicularly to one another.

In one embodiment, two or more of the strand layers each include a pre-formed strand board extending across the container flooring board in both of the first direction and the second direction.

In one embodiment, at least the top strand layer and the bottom strand layer each include a pre-formed strand board extending across the container flooring board in both of the first direction and the second direction.

In one embodiment, each strand layer includes a pre-formed strand board extending across the container flooring board in both of the first direction and the second direction.

In one embodiment, each strand layer includes a pre-formed strand board extending across the container flooring board in the second direction.

In one embodiment, each container flooring board is formed by pressing and heating a mat including the plurality of strand layers.

In one embodiment, each container flooring board includes one or more outer seal layers bonded to at least one of the top strand layer and the bottom strand layer of the container flooring board.

In one embodiment, the one or more outer seal layers are formed from rosined paper.

In one embodiment, the container includes laterally extending cross members for supporting the container flooring, and the method includes arranging the plurality of container flooring boards inside the container so that each container flooring board is supported by at least two laterally extending cross members.

In one embodiment, the method includes fitting at least one additional laterally extending cross member into the container so that each container flooring board is supported by at least two laterally extending cross members.

In another broad form an aspect of the present invention seeks to provide a container flooring board for use in providing container flooring for a container, the container flooring board including a plurality of strand layers, each layer including strands of wood bonded together with a binder including an isocyanate resin, wherein at least a top strand layer and a bottom strand layer of the container flooring board has its strands substantially aligned in a first direction, and wherein a dimension of the container flooring board in a second direction that is perpendicular to the second direction is selected to extend laterally between sides of the container in use.

In one embodiment, the container flooring board has a dimension in the second direction of about 2.4 m.

In one embodiment, the container flooring board has a dimension in the first direction of one of: about 1.2 m; and about 2.4 m.

In one embodiment, each container flooring board has a minimum thickness of about 28 mm.

In one embodiment, the container flooring board is formed from a laminate of the plurality of strand layers, each strand layer including at least one pre-formed strand board including substantially aligned strands, the respective strands of adjacent layers being oriented substantially perpendicularly to one another.

In one embodiment, two or more of the strand layers each include a pre-formed strand board extending across the container flooring board in both of the first direction and the second direction.

In one embodiment, at least the top strand layer and the bottom strand layer each include a pre-formed strand board extending across the container flooring board in both of the first direction and the second direction.

In one embodiment, each strand layer includes a pre-formed strand board extending across the container flooring board in both of the first direction and the second direction.

In one embodiment, each strand layer includes a pre-formed strand board extending across the container flooring board in the second direction.

In one embodiment, surfaces of each strand layer are substantially flat.

In one embodiment, the surfaces of each strand layer are sanded flat.

In one embodiment, at least one surface of each strand layer is glued to a surface of an adjacent strand layer to form the laminate.

In one embodiment, the strand layers are glued together using a Poly Urethane Reactive (PUR) glue.

In one embodiment, the container flooring board is formed by pressing and heating a mat including the plurality of strand layers.

In one embodiment, the container flooring board includes a central strand layer having randomly oriented strands.

In one embodiment, the container flooring board includes one or more outer seal layers bonded to at least one of the top strand layer and the bottom strand layer of the container flooring board.

In one embodiment, the one or more outer seal layers are formed from rosined paper.

In one embodiment, each strand layer has substantially equal thickness.

In one embodiment, each strand layer has a thickness of between 5 mm and 50 mm.

In one embodiment, the strands are formed from hardwood.

In one embodiment, the strands are formed from wood of one or more eucalypts.

In one embodiment, the eucalypts are selected from the species selected from the group consisting of: Tasmanian Bluegum (E. Globulus); Karri (E. Diversicolor); Sydney Bluegum (E. Saligna); Marri (E. Calophylla); Jarrah (E. Marginata); Shining Gum (E. Nitens); Flooded Gum (E. Grandis); E. Grandis x Urophylla; E. Nitens x Globulus; and hybrids of the aforementioned species.

In one embodiment, the strands are formed from softwood.

In one embodiment, the strands are formed from wood of one or more pines.

In one embodiment, the strands are formed from wood of two or more different species.

In one embodiment, the binder includes a polymeric methane di-isocyanate resin.

In one embodiment, the binder includes a wax.

In one embodiment, the strands have: an average length of between 145 mm and 300 mm; an average width of between 10 mm and 25 mm; and an average thickness of between 0.5 mm and 1.5 mm.

In one embodiment, for each strand layer having substantially aligned strands, one of: at least 75% of the strands are aligned; at least 85% of the strands are aligned; and at least 95% of the strands are aligned.

In one embodiment, the container flooring board has a density of one of: at least 700 kg/m³; between 700 kg/m³ and 900 kg/m³; and between 800 kg/m³ and 850 kg/m³.

In one embodiment, the container flooring board includes an odd number of strand layers.

In one embodiment, the container flooring board according is formed from one of: three layers; and five layers.

In one embodiment, the strands have been treated for insects.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

Various examples and embodiments of the present invention will now be described with reference to the accompanying drawings, in which: —

FIG. 1 is a perspective view of an example of a typical structure of a standard container (walls and flooring hidden for clarity);

FIG. 2 is a plan view of an example of a typical arrangement of traditional container floorboard panels for providing flooring in a standard 6.1 m (20 ft) long container;

FIG. 3 is a plan view of a first example of container flooring for a standard 6.1 m (20 ft) long container;

FIG. 4 is a plan view of a second example of container flooring for a standard 6.1 m (20 ft) long container;

FIG. 5A is a schematic perspective view of a first example of a container flooring board for providing container flooring for a container;

FIG. 5B is a schematic end view of the container flooring board shown in FIG. 5A;

FIG. 6 is a schematic exploded perspective view of a second example of a container flooring board for providing container flooring for a container

FIG. 7 is a flow diagram of the process for manufacturing strand boards for use in a cross laminated strand product; and

FIG. 8 is a flow diagram of the process for manufacturing a cross laminated strand product.

### DETAILED DESCRIPTION OF THE PREFERRED EMBODIMENTS

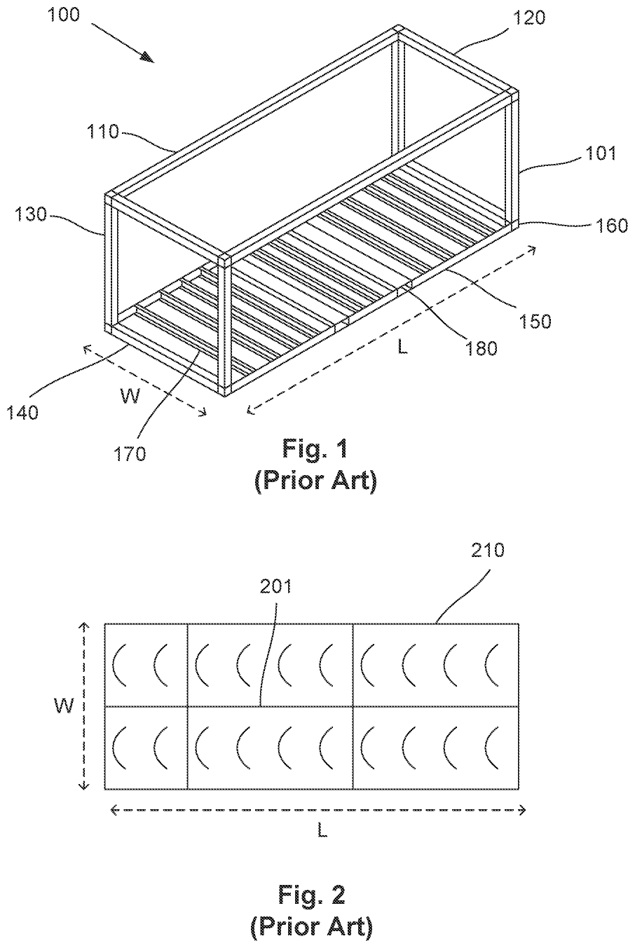

An example of a method for providing container flooring will now be described. This example should be considered in the context of the typical structure of a standard container 100 as shown in FIG. 1 and may be contrasted against the typical arrangement of traditional container floorboard panels 210 for providing flooring as shown in FIG. 2, as both discussed above.

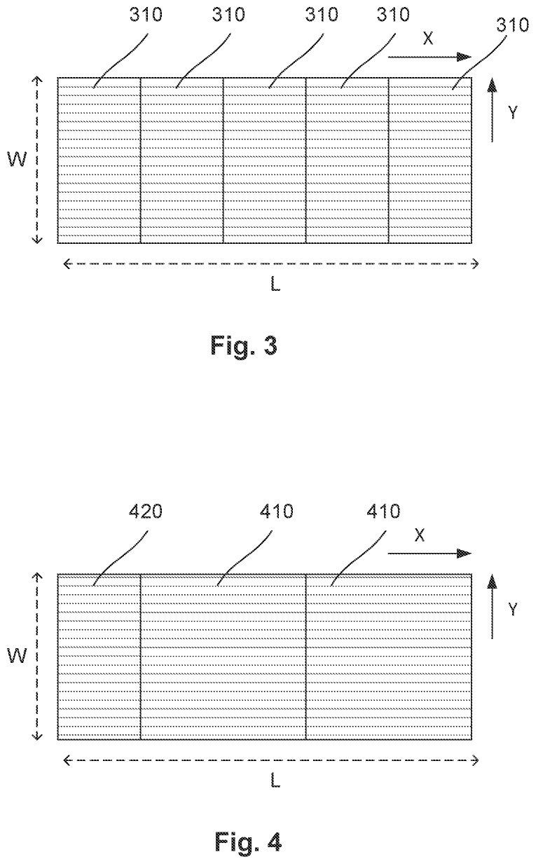

In broad terms, the method involves providing a plurality of container flooring boards, and arranging the plurality of container flooring boards inside the container to provide container flooring. The container flooring boards have a particular configuration, as discussed in further detail below, that allows them to be provided in a particular arrangement in the container as shown, for example, in FIGS. 3 and 4, which depict arrangements of container flooring provided in accordance with the method, for a standard 6.1 m (20 ft) long container.

In the present method, each container flooring board includes a plurality of strand layers, each strand layer including strands of wood bonded together with a binder including an isocyanate resin. Each container flooring board is configured so that at least a top strand layer and a bottom strand layer of the container flooring board has its strands substantially aligned in a first direction. Furthermore, a dimension of the container flooring board in a second direction that is perpendicular to the first direction is particularly selected to extend laterally between sides of the container in use.

The plurality of container flooring boards is arranged inside the container to provide container flooring. In particular, each container flooring board is positioned so that the strands of the upper layer and the lower layer of the container flooring board are substantially aligned longitudinally relative to the container, and the container flooring board extends laterally between the sides of the container. In addition, respective edges of adjacent container flooring boards abut one another.

With regard to the example of FIG. 3, it will be seen that the container flooring boards 310 are provided in the above discussed arrangement. In the plan view of FIG. 3, the orientation direction of the strands of the top strand layer, depicted by parallel lines, extends in the indicated ‘X’ direction, which corresponds to the first direction mentioned above. The container flooring boards 310 are dimensioned in the indicated ‘Y’ direction, which corresponds to the second direction mentioned above, such that they extend laterally between sides of the container in use. In other words, the container flooring boards 310 effectively span across the width of the container, and have top and bottom strand layers that are effectively aligned with the length of the container.

With regard to the example of FIG. 4, it will be appreciated that this example provides a similar arrangement as described above for FIG. 3, but uses a number of container flooring boards 410 which have longer dimensions in the first ‘X’ direction compared to the container flooring boards 310 in the previous example, along with an additional container flooring board 420 that is dimensioned as required to provide full container flooring coverage in the container. Nonetheless, the container flooring boards 410, 420 effectively span across the entire width of the container and have upper and lower strand layers which are effectively aligned with the length of the container.

As mentioned above, FIGS. 3 and 4 depict container flooring arrangements for a standard 6.1 m (20 ft) long container. In both examples, the container flooring boards 310, 410, 420 each have a dimension in the second ‘Y’ direction of about 2.4 m. It will be appreciated that this dimension generally corresponds to the typical width of a standard container. In order to manufacture container flooring boards satisfying this dimension requirement, the pre-formed boards used to form the strand layers of the container flooring boards will need to be manufactured with sufficient dimensions themselves. Fortunately, continuous presses and multi-daylight presses are available that are capable of forming strand boards that are 2.4 m wide. It should be appreciated that traditional plywood container flooring with sufficient width (measured perpendicular to the grain of the top and bottom veneers) to span the width of a standard container has not previously been available due to manufacturing and raw material limitations.

It is noted that the container flooring boards 310, 410, 420 in these examples may have different dimensions in the first ‘X’ direction. In the case of FIG. 3, the container flooring boards 310 have a dimension in the first ‘X’ direction of about 1.2 m, such that five of the boards may be arranged along the length of the container in an end-to-end relationship. In the case of FIG. 4, the two of the container flooring boards 410 have a dimension in the first ‘X’ direction of about 2.4 m and another one of the container flooring boards 420 has a dimension in the first ‘X’ direction of about 1.2 m, such that only three boards are needed to fill the length of the container.

It should be appreciated that a range of different dimensions in the first ‘X’ direction may be selected depending on requirements. For example, container flooring boards 310 as shown in FIG. 3 may be preferred over the container flooring boards 410 for ease of transportation and installation. In other examples, alternative dimensions in the first ‘X’ direction may be selected depending on other considerations, such as the arrangement of floor supports (e.g. cross members 170 as shown in FIG. 1) in the container.

It will be appreciated that the above described method provides an alternative container flooring solution which brings useful advantages compared to traditional container flooring solutions as discussed above.

The use of pre-formed boards formed from layers of bonded strands of wood allows container flooring to be provided using fast-growth wood, in contrast to traditional techniques using veneers of old-growth wood. This allows more sustainable sources of wood to be used, but also enables the particular board configuration as required by this method. In particular, forming the container flooring boards from strands of wood avoids the restrictions in board dimensions that have traditionally been imposed upon plywood container flooring which led to the typical arrangements as shown in FIG. 2.

In contrast to traditional arrangements, the present method involves laying down the container flooring boards in the container in a manner that allows the bending sheer forces to be evenly distributed to the container walls, which still having the top and bottom strand layers of the container flooring boards oriented parallel to the length of the container. It will be appreciated that the container flooring boards are laid in the container in a perpendicular manner contrary to current practice of boards being laid in a parallel fashion (this can be observed, for instance, by directly comparing the example of FIG. 3 to the traditional arrangement of FIG. 2).

Accordingly, in the present method, the container flooring boards are placed in the container in such a manner as to form a bridging of the loading forces to the side walls of the container. This can be contrasted with the traditional method of laying down floor boards as in FIG. 2 which results in an unsupported split extending along the centreline of the container such that applied shear forces are unevenly distributed and bending is allowed to take place at the unsupported edge of the board. This is bad design as the maximum bending moment is at the centreline of the container where the traditional arrangement of conventional container floor boards abut each other without any support other than the cross members underneath. Conversely, in the present method the container flooring boards are continuous over the entire width of the container, allowing the maximum bending moment at the centreline to be better distributed over the entire width of the container.

Each container flooring board will preferably have a minimum thickness of about 28 mm, as defined by the IICL. Furthermore, each container flooring board will preferably have a minimum density of about 700 kg/m³, as defined by the IICL, although in practice higher densities may be provided as discussed below.

In some embodiments, each container flooring board is formed from a laminate of a plurality of strand layers, each strand layer including at least one pre-formed strand board having substantially aligned strands, the respective strands of adjacent layers being oriented substantially perpendicularly to one another. This form of strand board is a form of a “cross laminated strand product” as disclosed in AU2011202472B2, the entire contents of which are incorporated herein by reference. Accordingly, suitable container flooring boards may be provided in accordance with the techniques disclosed in AU2011202472B2.

The container flooring boards may thus be provided in the form of cross laminated strand boards, which provide suitable wood composite boards having sufficient mechanical and physical strength and durability for use as container flooring. Container flooring boards provided in this manner will typically have a uniform density of between 700 kg/m³ and 900 kg/m³. It has been found that the use of cross laminated strand boards does not require the use of any added stiffening, such as outer veneer layers, to meet the container flooring properties. The present method may thereby combine the benefits of cross laminated strand products as discussed in AU2011202472B2 with the capability to manufacture strand boards with dimensions that allow the boards to be laid across the width of the container, which has not previously been an option using traditional types of boards such as plywood.

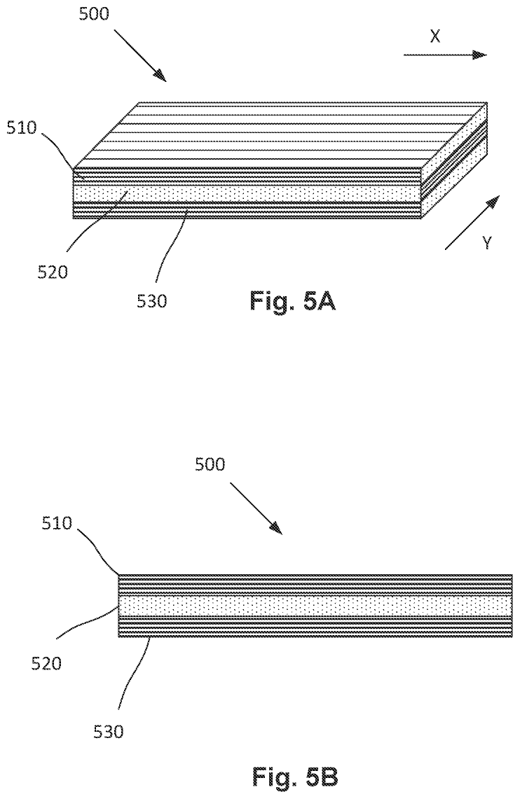

A first example of a container flooring board for use in the above method, provided in the form of a cross laminated strand product, will now be described with reference to FIG. 5A and FIG. 5B.

The cross laminated strand product 500 is manufactured from a laminate of a plurality of strand layers. Each strand layer includes at least one pre-formed strand board including substantially aligned strands of wood bonded together with a binder including an isocyanate resin. In this case, the respective strands of adjacent strand layers are oriented substantially perpendicularly to one another.

Each of the strand layers of the cross laminated strand product 500 has strands substantially aligned in a single direction, and adjacent strand layers are distinguished from one another by the particular orientation direction of the strands in that layer. For example, the orientation direction of strand layers may alternate between a direction parallel to the length dimension of the cross laminated strand product (“length-wise”) and a direction parallel to a width dimension of the cross laminated strand product (“cross-wise”).

It should be noted that references made herein to “length” and “width” dimensions of the board are used to facilitate description and are not intended to imply that a particular dimension of the product is greater than the other. Although the pre-formed strand layers will typically be formed to have an elongate length in comparison to their width, the final resulting product can be finished with desired dimensions that do not necessarily retain the same relationships.

In any event, by forming a laminate of pre-formed strand layers with strands oriented in alternating directions, a cross laminated strand product 500 can be formed with strand layers having controlled thicknesses and well-defined interfaces between their respective surfaces, and a good degree of alignment of strands in each direction. As the strand layers are laminated with strand layers alternating between length-wise and cross-wise, this manufacturing process can be described as “cross laminating”, hence the use of the term “cross laminated” strand product.

The cross laminated strand product 500 is referred to as “cross laminated strand board” when provided with relatively small total thickness, as it will typically be provided for use as a container flooring board.

The cross laminated strand product 500 described above helps to overcome deficiencies of conventional strand products, such as OSB products. For example, the cross laminated strand product 500 helps to mitigate the relatively poor definition and control of strand layers which can be problematic in the manufacture of conventional strand products, in which the strands are deposited in layers across the thickness of the board by merely changing the orientation of the strands deposited throughout the mat formation process. Variations in the layer thicknesses and poor definition of the layer boundaries result in variations in the resulting material properties in each direction. In order to account for these variations, minimum performance ratings for conventional strand products must be reduced to account for the worst-case layer configurations, or quality control measures must be taken to reject conventional strand products failing to meet set criteria.

In contrast, the cross laminated strand product 500 can be provided with well-defined strand layers such that the layer configurations are more tightly controlled. The variations in the strand layer configurations are greatly reduced, and as a result, cross laminated strand products 500 as described above can be manufactured with higher performance ratings, and/or fewer rejects. Each strand layer can be pre-formed using the same forming process so that the strand layers have consistent thickness and surface properties. Further details of how the strand layers are formed will be provided below.

Furthermore, the cross laminated strand product 500 helps to mitigate the relatively low degree of alignment in the cross-wise direction, which is typically found in conventional strand products. The manufacture of conventional strand products typically utilizes a continuous process where the products are formed sequentially along a conveyor belt. Current continuous strand product manufacturing processes typically allow for high alignment in the direction of travel of the conveyor belt, but relatively lower alignment across the conveyor belt. As a result, conventional strand products have traditionally delivered relatively low performance in the cross-wise direction.

In contrast, the strand orientation direction of the strand layers of the cross laminated strand product 500 is controlled by the arrangement of the strand layers in the laminate, and not by the alignment of strands as they are deposited in layers during mat formation. Each of the strand layers of the cross laminated strand product 100 can be provided by one or more pre-formed strand boards, where each board is formed from a mat with strands substantially aligned in the direction of travel the conveyor belt across the entire board thickness. These pre-formed boards can be cross laminated to form the cross laminated strand product 500 so that a good degree of alignment is achieved for each strand layer.

It will be appreciated that the cross laminated strand product 500 also offers some of the benefits of plywood, such as well controlled layer properties, without requiring high quality peeling logs for the production of veneers. Faults in veneer sheets and resulting reduction in performance is a common problem in the production of plywood, however the cross laminated strand product 500 avoids this, as any faults in the wood are distributed homogeneously through the layers due to the use of strands in the layers. Accordingly, the cross laminated strand product 500 is suitable as a sustainable alternative to plywood in container flooring applications.

Referring again to FIG. 5A and FIG. 5B, this example of a cross laminated strand product 500 includes three strand layers, namely a top layer 510, a core layer 520, and a bottom layer 530. The strands of the top layer 510 and the bottom layer 130 are substantially aligned length-wise, in the direction indicated by the arrow labelled ‘X’. On the other hand, the strands of the core layer 520 are substantially aligned cross-wise, in the direction indicated by the arrow labelled ‘Y’, such that the alignment of the strands in the core layer is perpendicular to the alignment of the strands in the adjacent top layer 510 and bottom layer 520.

As mentioned above, references to length and width of the product are used herein for convenience but should not be taken to imply that one dimension of the product is greater or less than another dimension of the product. For instance, the final product can be cut to any desired ‘length’ dimension, including dimensions that are less than the manufactured ‘width’ dimension of the product. Indeed, in the embodiments of the container flooring boards 310 shown in FIG. 3, the boards have shorter dimensions in the ‘X’ direction (referred to as length-wise) compared to the ‘Y’ dimension (referred to as cross-wise), whereas the embodiments of the container flooring boards 410 shown in FIG. 4 have equal dimensions in the ‘X’ direction and the ‘Y’ dimension.

Although the cross laminated strand product 500 in this example includes three strand layers, it will be appreciated that any number of strand layers can be used. However, an odd number of strand layers is typically used, so that the two outer layers (i.e. the top and bottom layers) have the same alignment, usually in the length-wise direction. This arrangement helps to improve the length-wise performance characteristics of the cross laminated strand product in the alignment direction of the outer layers, which is desirable for structural applications. In particular, by providing aligned outer layers, the length-wise bending performance is improved.

The use of an odd number of strand layers also means that the strand layers can be symmetrically arranged about a central core layer, with increased number of strand layers being added as intermediate layers between the core and surface layers.

The use of a number of strand layers greater than three, such as five or seven layers, helps to improve the cross-wise performance characteristics of the cross laminated strand product. For example, improved cross-wise tensile performance can be achieved because cross sectional area of the cross-wise layers as a proportion of the total cross sectional area of the cross laminated strand product 500 increases as the number of strand layers increases. Furthermore, by providing additional cross-wise layers with greater separation from the centre plane, the cross-wise bending performance is improved. It will also be understood that cross laminated strand lumber suitable use in desired container flooring applications can be provided by the selecting the number of layers, and the layer thicknesses to deliver the required strength.

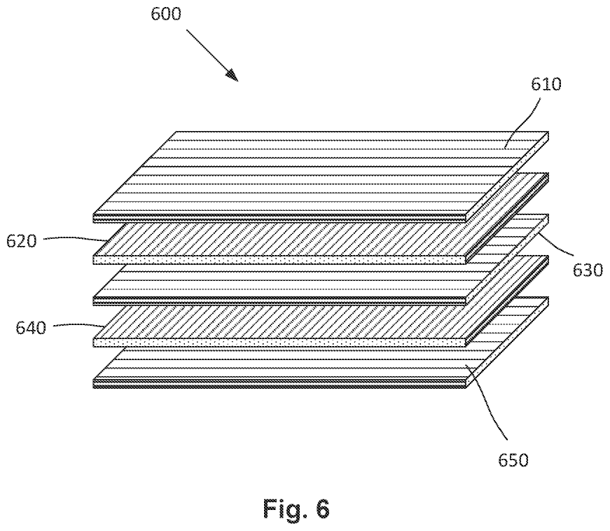

An example of a five layer cross laminated board product 600 is shown in exploded view in FIG. 6, in order to illustrate the strand layer configuration in more detail. In this example, the top layer 610, bottom layer 650 and core layer 630 each have length-wise alignment, whilst the upper and lower intermediate layers 620, 640 have cross-wise alignment.

In some embodiments, two or more of the strand layers may each include a pre-formed strand board extending across the container flooring board in both of the first direction (i.e. length-wise) and the second direction (i.e. cross-wise). Preferably, at least the top layer and the bottom layer each include a pre-formed strand board extending across the container flooring board in both of the first direction and the second direction. This will ensure that each container flooring board has no joints between pre-formed strand boards in its outer-most layers, where joints would have the most detrimental effect to the product.

More preferably, each strand layer includes a pre-formed strand board extending across the container flooring board in both of the first direction and the second direction, as shown in the example of FIG. 6. This can completely eliminate any adverse effects due to internal joints between pre-formed strand boards. It will be understood that the capability of achieving this requirement will depend on the original dimensions of the pre-formed strand boards which make up the strand layers of the container flooring board, and the final dimensions of the container flooring board itself.

In practice, this will require that pre-formed strand boards be manufactured so that their minimum dimension (typically perpendicular to the orientation direction of the strands) is at least equal to the maximum dimension of the container flooring board, such that the strand layers will not have internal joints as discussed above. So to provide a container flooring board having a dimension in the second direction of about 2.4 m (to allow it to span the width of a standard container), the pre-formed strand boards used to make the container flooring board would have a width dimension of about 2.4 m perpendicular to the orientation of its strands in its length dimension. However, it should be appreciated that, as discussed above, container flooring boards having different dimensions in the first direction may be provided by effectively cutting the board to different lengths.

It may also be preferable to form the container flooring board so that each pre-formed strand board extends across the container flooring board in the second direction, so that each layer is continuous across the width of the container. This can help to avoid joints extending length wise relative to the container. Accordingly, there would not be any discontinuities in the pre-formed strand boards forming the layers in vicinity of the centreline of the container, where the bending moment is maximum, in contrast with the parallel arrangement of the current conventional configuration of container floor boards.

The boards used to form each layer can be manufactured in a continuous process, so that the lengths of the boards are only constrained by the length handling capacity of the board manufacturing plant. However, it will be appreciated that longer board lengths will not be of much practical use if the goal is to provide cross laminated strand products without any joints in the layers, for container flooring applications.

In one example, the layers have substantially equal thicknesses. In this case, each of the layers are cut from boards manufactured using the same manufacturing technique, irrespective of the orientation of the layer in the laminate. However, it will be appreciated that cross laminated strand products can be provided with varying layer thicknesses. For example, by varying the thicknesses of the individual layers, it is possible to adjust the performance of the cross laminated strand product, such as strength, in any direction.

The thickness of each layer is determined by the process used to manufacture the board for the layers.

The minimum layer thickness used in cross laminated strand products will typically be limited by the economic viability of manufacturing thinner boards, as strand board manufacturing processes will typically become uneconomical for boards thinner than a particular thickness. In one example, the minimum board thickness is about 5 mm.

On the other hand, the maximum layer thickness may be limited by the capacity of the pressing technology implemented in the manufacturing plant. For example, the maximum board thickness manufactured using typical continuous hot press technology is about 50 mm. The use of pre-heating in advance of the press can allow thicknesses up to about 70 mm. The production of board thicknesses greater than about 70 mm using continuous press technology can be problematic due to pre-curing of the isocyanate resin.

In one example, the boards are manufactured using similar manufacturing plants as used for conventional strand products such as oriented strand board (OSB), oriented strand lumber (LSL), or laminated strand lumber (LSL). Therefore, the individual boards used to make up the layers of the cross laminated strand product can be manufactured with thicknesses up to the maximum thickness of conventional strand products. The total thickness of the cross laminated strand product will be dependent on the number of layers and the layer thicknesses. This means that the total thickness of cross laminated strand products are not limited by the board pressing technology, and therefore greater total thicknesses can be achieved than the thicknesses of OSB products and the like, because the total thickness can be increased by adding layers.

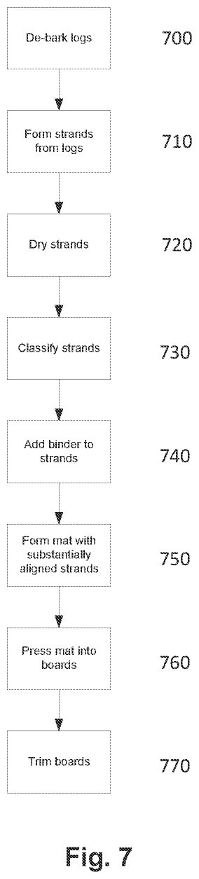

An example of a process used to manufacture the boards of each layer will now be described with reference to FIG. 7. The process outlined here is based on the Siempelkamp CONTIROLL system and is given by way of example only. It will be appreciated that the layers can be manufactured using a variety of processes for manufacturing strand products.

The process begins with harvested logs. The source of logs is not particularly limited, but it will be appreciated that the final properties of the resulting cross laminated strand product will be affected by the choice of wood. In one example, the strands are formed from hardwood, such as trees from one or more eucalypt species. Eucalypt plantations provide a sustainable hardwood source, and strand products formed from eucalypts have been found to offer desirable performance properties.

Examples of suitable eucalypt species include Bluegum (E. Globulus), Karri (E. Diversicolor), Sydney Bluegum (E. Saligna), Marri (E. Calophylla), Jarrah (E. Marginata), Shining Gum (E. Nitens), E. Grandis x Urophylla, E. Nitens x Globulus, and hybrids of the aforementioned species.

In the case of plantation trees such as Bluegum (E. Globulus), Sydney Bluegum (E. Saligna) and Shining Gum (E. Nitens), the strands can be formed from trees having an age of 12 years or less, with diameters of around 150 to 300 mm. In the case of forest thinnings such as Karri (E. Diversicolor), Marri (E. Calophylla) or Jarrah (E. Marginata) the strands can be formed from trees having an age of less than 30 years and with diameters less than 400 mm. Single species may be used in a particular product or multiple species may be combined.

In another example, the strands are formed from softwood, such as trees from pine, cedar, fir or yew species. In particular, pine plantations are a well established renewable wood resource capable of providing high yields of trees suitable for stranding.

It is also possible to use strands formed from more than one species. For example, the strands of different layers may be formed from wood from different species. In another example, strands of different species may be mixed in the same layer. By combining multiple species of wood in the layers to produce a “hybrid” product, the properties of the cross laminated strand product 100 can be controlled based on the particular combination of species.

At step 700 the logs are debarked before passing through a strander to form strands from the logs at step 710. A ring strander is typically used to cut logs of fixed or random length into strands of a specified length, width and thickness. The strands are preferably formed with a length of about 145 mm to 300 mm, a width of about 10 to 25 mm and a thickness of about 0.5 to 1.5 mm.

The strands are dried at step 720 to preferably less than 5% moisture and are then classified in sieves at step 730 according to product specifications. A strand holding bin holds the dried and classified strands until required.

Waste bark or rejected strands and fines can provide the fuel for a heat plant that generates heat for the drier and other parts of the process. About 70% of the original logs can be used to form product. Most of the remaining 30% can be used in the heat plant.

At step 740 a binder is added to the strands. Typically, this involves conveying the strands on demand to a resin blender in which resin and wax are added in required proportions, typically about 6 to 10% of dry matter and 2% of dry matter respectively. The mixed strand, resin and wax is known as “furnish” and is typically held in a furnish holding bin.

The preferred resin is an isocyanate binder such as polymeric methane di-isocyanate (PMDI). The preferred wax is a paraffin emulsion such as MOBILCER available from Mobile Australia, or similar products available from Dynea and Oest. Other additives such as pesticides, fungicides and fire retardants can be added at this point and mixed to ensure uniform distribution throughout the finished product matrix.

At step 750, the furnish is supplied to a mat former where the strands are substantially aligned in the direction of the conveyor belt and deposited onto the conveyor belt to form a mat of the required mass. A combination of alignment and mass controls the mechanical properties of the mat produced. The strands are formed in substantially aligned or unidirectional arrangement. Typically, at least 75% of the strands are aligned; however, it is preferable for at least 85% of the strands to be aligned and it is possible for greater than 95% of the strands to be aligned using modern disc formers to orient the strands.

The performance properties of the board in the alignment direction increase as the strand alignment increases, and therefore high strand alignments are preferable. Accordingly, in one example, at least 95% percent of the strands are substantially aligned. Measurements of the alignment of the strands in test products have shown that the mean angle of the strands from the intended alignment direction is 11.4 degrees.

In one example, the mat then passes a checking station which carries out weight, moisture and metal detection. Any rejected material is conveyed either as waste to the heat plant or set aside for special processing.

In any event, at step 760 the mats are pressed into boards. This may involve passing the mats through a preheating station prior to passing the mat through a continuous press. Typical continuous board manufacturing processes produces boards up to 2.7 m wide and 15 m long. In this example, the press heats the material to above 100° C. for at least 1 minute.

Following pressing, the boards are cooled and trimmed and at step 770.

The resulting boards have a substantially uniform density of between 700 kg/m³ and 900 kg/m³.

Up to this stage, the boards may be manufactured using common techniques for manufacturing strand boards.

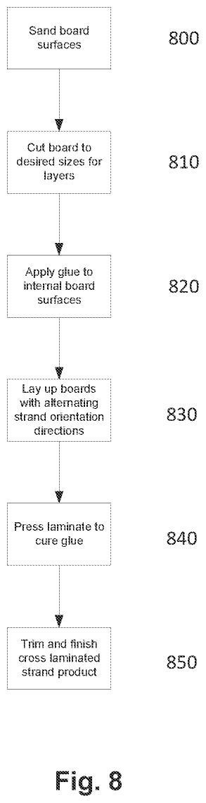

With the manufacture of the boards completed, the process of forming the laminate can commence, using one or more of the boards to form each of the layers. An example process for manufacturing the cross laminated strand product using the manufacture boards will now be described with reference to FIG. 8.

Preferably, the surfaces of the boards are substantially flat, in order to facilitate the lamination process. Accordingly, at step 800, the surfaces of the boards may be sanded or otherwise treated after their manufacture to attain a desired surface roughness.

Since the orientation of the layers alternates, the dimensions of boards used in the length-wise layers may be different to the dimensions of the boards used in the cross-wise layers, such that the length of the cross-wise layers are equal to the width of the length-wise layers. Accordingly, the boards are cut to the desired sizes for the layers at step 810.

As discussed above with reference to FIG. 6, it is possible to manufacture a cross laminated strand product having a maximum dimensions equal to the width of the pre-formed board used to make up the strand layers. This allows a cross laminated strand product that is 2.4 m wide, which is equivalent to the board size that can be manufactured by a typical continuous press. Conveniently, this corresponds to the dimension required to allow the container flooring board to extend laterally between sides of the container, as discussed above.

In another example of a strand product having three layers, the top and bottom layers can be boards of the full board dimensions, whilst boards to be used in the core layer can be cut to lengths equal to the width of the full board dimension, and arranged side-by side so that a number of boards span the length of the cross laminated strand product in the core layer.

It will be appreciated that cross laminated strand products of any dimension smaller than the manufactured board dimension can be produced in this manner, such that each of the top and bottom layers are made from a single board. To allow for the preferred configuration in which no external or internal joints are used, the maximum dimensions of the cross laminated strand product may be limited to 2.4 m wide×2.4 m long, as shown in FIG. 4. However, for improved handling it may be preferable to provide the cross laminated strand product in a shorter, rectangular configuration, such as with dimensions of 2.4 m wide×1.2 m long, as shown in FIG. 3.

In any event, with the boards sanded and cut to size, the boards are then laid up, alternating between the length-wise and cross-wise boards, to form the laminate. The process of laying up the boards is similar to that used to manufacture plywood, but some different techniques are required given that the boards of each layer are substantially thicker than the veneers used in plywood.

As the boards are laid up, at least one surface of each layer is glued to a surface of an adjacent layer to form the laminate. In one example, the layer surfaces are glued together using Polyurethane Reactive (PUR) glue. However, it will be appreciated that numerous types of glues will be suitable, such as phenolic and formaldehyde based glues which are commonly used in plywood manufacture.

It will be appreciated that different processes for applying the glue to the layers during lay up of the laminate can be used, and varying levels of automation of these processes may be implemented.

In this example, glue is applied to the internal board surfaces at step 820 and the boards are progressively laid up with alternating strand orientation directions at step 830.

However, in another example, glue is applied to the upper surface of each board as each layer is added to the laminate, with the exception of the top layer. In another example, glue is applied to both the upper and lower surface of each cross-wise layer only, which will also result in each layer being glued together.

For thinner cross laminated strand boards with thicknesses up to 30 mm, such as those used in flooring, the gluing and lay up processes may be automated. However, thicker cross laminated strand products may require manual gluing and lay up processes.

Once the desired number of layers has been glued and laid up, the laminate is pressed and the glue is allowed to cure at step 840. The press can be heated or unheated, and the choice of pressing parameters such as pressure and duration will be subject to a number of factors the type of glue and wood being used, the board thickness and the number of layers.

The pressing system used to press the strand board layers in the laminate is similar to pressing systems commonly used in plywood manufacture.

The pressing and curing stage may result in some further compression of the final product such that the total thickness is less than the sum of the individual layers. In one example, a five layer cross laminated strand product formed from 6 mm thick boards results has a final thickness of 28 mm.

After the glue is cured, the cross laminated strand product is trimmed and finished at step 850. This can involve sanding the edges and treating the exterior of the cross laminated strand product as necessary to provide a finished cross laminated strand product with the desired dimensions and external properties.

As demonstrated in the test results discussed in AU2011202472B2, the performance of the cross laminated strand product exceeds the standard performance levels of conventional strand products and compares favourably with high end structural plywood. Accordingly, the cross laminated strand product is suitable for container flooring applications as a sustainable substitute for those conventional products.

As discussed above, plywood panels formed from hardwood veneers sourced from old growth tropical forests are commonly used for container flooring for their durability, as the flooring has to withstand the rigors of loading and unloading of containers by forklifts and the like. The use of container flooring boards provided in the form of a cross laminated strand product manufactured from renewable wood sources such as plantation eucalypts will therefore help to reduce the strain on the remaining tropical hardwood forest reserves.

When provided for use as container flooring boards, the cross laminated strand product may be manufactured in compliance with an appropriate standard. For example, the Institute of International Container Lessors (IICL) Performance Standard for New and Unused Structural Container Floor Panels To Be Installed In International Freight Containers is typically used by the major container manufacturers. Although this standard specifically relates to plywood, bamboo and OSB structural container floor panels, it is noted that cross laminated strand products meeting the performance requirements set out in the IICL standard will be suitable for replacing these other types of products in container flooring applications.

A specific example of a cross laminated strand product configuration particularly suitable for use as a container flooring board will be described. However, it will be appreciated that other configurations may also be used to provide suitable container flooring boards, as discussed in general terms above.

In this example, the cross laminated strand product is 28 mm thick and formed from five strand layers (as shown in FIG. 6). The strand layers are formed from strand boards with an initial thickness of 6 mm, such that some compression of the total thickness occurs in forming the laminate.

The strand boards may be manufactured using strands from a eucalypt species and the binder is a polymeric methane di-isocyanate resin. The strands may also be treated to eliminate insects such as termites, as this is an important requirement for container flooring. For example, the treatment may be in accordance with Australian Quarantine and Inspections Service (AQIS) standards. Preferably, the treatment shall incorporate an approved treatment as required by the Australian Commonwealth Department of Health Division of Plant Department (TCT). Ideally, any pesticide treatment used will be compatible with multiple species of wood.

A continuous manufacturing process is used with a hot pressing stage. The strands are aligned in the conveyor belt direction during mat formation using disc formers, resulting in at least 95% of the strands being aligned. The surfaces of the strand boards are sanded in preparation for laminating.

In this example, the strand boards are glued together using a Poly Urethane Reactive (PUR) glue to form the layers of the cross laminated strand product.

The preferred mechanical and physical properties of container flooring boards formed in accordance with the above techniques are as follows:
Modulus of Rupture (MOR) in parallel direction: about 80 MPa;
Modulus of Rupture (MOR) in perpendicular direction: about 30 MPa;
Modulus of Elasticity (MOE) in parallel direction: about 10,000 MPa;
Modulus of Elasticity (MOE) in perpendicular direction: about 3,000 MPa; and
Panel density: 800 to 850 kg/m³.

The top and bottom support layer may include a wood-strand layer or alternatively may include one or more outer seal layers bonded to at least one of the top strand layer and the bottom strand layer of the container flooring board. For example, these outer seal layers may be formed from a layer of rosined paper for sealing the surface.

Whilst it is desirable to provide cross laminated strand boards as the container flooring boards in the above method, it is noted that this is not essential, and in some embodiments, suitable container flooring boards may be provided using other construction techniques.

In some alternative examples, each container flooring board may be formed by pressing and heating a mat including the plurality of strand layers. For example, other suitable forms of strand boards may be used, such as eucalyptus strand boards manufactured in accordance with techniques disclosed in AU2004314464B2, the entire content of which is incorporated herein by reference.

Whilst eucalyptus strand boards as disclosed in AU2004314464B2 and other forms of oriented strand boards (OSB) can be provided with suitable properties for container flooring, it will be appreciated that the resulting container flooring boards will typically have relatively poor alignment of strands in the cross-wise direction compared to cross laminated strand boards as described above.

In any event, the overall configuration of the container flooring boards and their arrangement within the container will be generally in accordance with the method described above, whether these are provided in the form of a cross laminated strand board, a eucalyptus strand board, or any other suitable strand board product, in that the top and bottom strand layers will be aligned longitudinally relative to the container will span across the width of the container. As discussed above, this can beneficially avoid unsupported edges along the centreline of the container as found in traditional container flooring, whilst the use of a strand product can further allow for the use of more sustainable wood sources.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1) A method for providing container flooring for a container, the method including:
a) providing a plurality of container flooring boards, each container flooring board including a plurality of strand layers, each strand layer including strands of wood bonded together with a binder including an isocyanate resin, wherein at least a top strand layer and a bottom strand layer of the container flooring board has its strands substantially aligned in a first direction, and wherein a dimension of the container flooring board in a second direction that is perpendicular to the first direction is selected to extend laterally between sides of the container in use; and
b) arranging the plurality of container flooring boards inside the container to provide container flooring, wherein each container flooring board is positioned so that the strands of the top strand layer and the bottom strand layer of the container flooring board are substantially aligned longitudinally relative to the container and the container flooring board extends laterally between the sides of the container, and wherein respective edges of adjacent container flooring boards abut one another.

2) A method according to claim 1, wherein each container flooring board has a dimension in the second direction of about 2.4 m.

3) A method according to claim 2, wherein at least some of the container flooring boards have a dimension in the first direction of one of:
a) about 1.2 m; and
b) about 2.4 m.

4) A method according to claim 1, wherein each container flooring board has a minimum thickness of about 28 mm.

5) A method according to claim 1, wherein each container flooring board is formed from a laminate of the plurality of strand layers, each strand layer including at least one pre-formed strand board including substantially aligned strands, the respective strands of adjacent layers being oriented substantially perpendicularly to one another.

6) A method according to claim 5, wherein two or more of the strand layers each include a pre-formed strand board extending across the container flooring board in both of the first direction and the second direction.

7) A method according to claim 6, wherein at least the top strand layer and the bottom strand layer each include a pre-formed strand board extending across the container flooring board in both of the first direction and the second direction.

8) A method according to claim 6, wherein each strand layer includes a pre-formed strand board extending across the container flooring board in both of the first direction and the second direction.

9) A method according to claim 5, wherein each strand layer includes a pre-formed strand board extending across the container flooring board in the second direction.

10) A method according to claim 1, wherein each container flooring board is formed by pressing and heating a mat including the plurality of strand layers.

11) A method according to claim 1, wherein each container flooring board includes one or more outer seal layers bonded to at least one of the top strand layer and the bottom strand layer of the container flooring board.

12) A method according to according to claim 11, wherein the one or more outer seal layers are formed from rosined paper.

13) A method according to claim 1, wherein the container includes laterally extending cross members for supporting the container flooring, and wherein the method includes arranging the plurality of container flooring boards inside the container so that each container flooring board is supported by at least two laterally extending cross members.

14) A method according to claim 1, wherein the method includes fitting at least one additional laterally extending cross member into the container so that each container flooring board is supported by at least two laterally extending cross members.

15) A container flooring board for use in providing container flooring for a container, the container flooring board including a plurality of strand layers, each layer including strands of wood bonded together with a binder including an isocyanate resin, wherein at least a top strand layer and a bottom strand layer of the container flooring board has its strands substantially aligned in a first direction, and wherein a dimension of the container flooring board in a second direction that is perpendicular to the first direction is selected to extend laterally between sides of the container in use.

16) A container flooring board according to claim 15, wherein the container flooring board has a dimension in the second direction of about 2.4 m.

17) A container flooring board according to claim 16, wherein the container flooring board has a dimension in the first direction of one of:
a) about 1.2 m; and
b) about 2.4 m.

18) A container flooring board according to claim 15, wherein each container flooring board has a minimum thickness of about 28 mm.

19) A container flooring board according to claim 15, wherein the container flooring board is formed from a laminate of the plurality of strand layers, each strand layer including at least one pre-formed strand board including substantially aligned strands, the respective strands of adjacent layers being oriented substantially perpendicularly to one another.

20) A container flooring board according to claim 19, wherein two or more of the strand layers each include a pre-formed strand board extending across the container flooring board in both of the first direction and the second direction.

21) A container flooring board according to claim 20, wherein at least the top strand layer and the bottom strand layer each include a pre-formed strand board extending across the container flooring board in both of the first direction and the second direction.

22) A container flooring board according to claim 20, wherein each strand layer includes a pre-formed strand board extending across the container flooring board in both of the first direction and the second direction.

23) A container flooring board according to claim 19, wherein each strand layer includes a pre-formed strand board extending across the container flooring board in the second direction.

24) A container flooring board according to claim 19, wherein surfaces of each strand layer are substantially flat.

25) A container flooring board according to claim 23, wherein the surfaces of each strand layer are sanded flat.

26) A container flooring board according to claim 19, wherein at least one surface of each strand layer is glued to a surface of an adjacent strand layer to form the laminate.

27) A container flooring board according to claim 19, wherein the strand layers are glued together using a Poly Urethane Reactive (PUR) glue.

28) A container flooring board according to claim 15, wherein the container flooring board is formed by pressing and heating a mat including the plurality of strand layers.

29) A container flooring board according to claim 15, wherein the container flooring board includes one or more outer seal layers bonded to at least one of the top strand layer and the bottom strand layer of the container flooring board.

30) A container flooring board according to claim 29, wherein the one or more outer seal layers are formed from rosined paper.

31) A container flooring board according to claim 15, wherein each strand layer has substantially equal thickness.

32) A container flooring board according to claim 15, wherein each strand layer has a thickness of between 5 mm and 50 mm.

33) A container flooring board according to claim 15, wherein the strands are formed from hardwood.

34) A container flooring board according to claim 33, wherein the strands are formed from wood of one or more eucalypts.

35) A container flooring board according to claim 34, wherein the eucalypts are selected from the species selected from the group consisting of:
a) Tasmanian Bluegum (E. Globulus);
b) Karri (E. Diversicolor);
c) Sydney Bluegum (E. Saligna);
d) Marri (E. Calophylla);
e) Jarrah (E. Marginata);
f) Shining Gum (E. Nitens);
g) Flooded Gum (E. Grandis);
h) E. Grandis x Urophylla;
i) E. Nitens x Globulus; and
j) hybrids of the above species.

36) A container flooring board according to claim 15, wherein the strands are formed from softwood.

37) A container flooring board according to claim 36, wherein the strands are formed from wood of one or more pines.

38) A container flooring board according to claim 15, wherein the strands are formed from wood of two or more different species.

39) A container flooring board according to claim 15, wherein the binder includes a polymeric methane di-isocyanate resin.

40) A container flooring board according to claim 15, wherein the binder includes a wax.

41) A container flooring board according to claim 15, wherein the strands have:
a) an average length of between 145 mm and 300 mm;
b) an average width of between 10 mm and 25 mm; and
c) an average thickness of between 0.5 mm and 1.5 mm.

42) A container flooring board according to claim 15, wherein, for each strand layer having substantially aligned strands, one of:
a) at least 75% of the strands are aligned;
b) at least 85% of the strands are aligned; and
c) at least 95% of the strands are aligned.

43) A container flooring board according to claim 15, wherein the container flooring board has a density of one of:
a) at least 700 kg/m³;
b) between 700 kg/m³ and 900 kg/m³; and
c) between 800 kg/m³ and 850 kg/m³.

44) A container flooring board according to claim 15, wherein the container flooring board includes an odd number of strand layers.

45) A container flooring board according to claim 44, wherein the container flooring board according is formed from one of:
a) three layers; and,
b) five layers.

46) A container flooring board according to claim 15, wherein the strands have been treated for insects.
